(19) United States
(12) Patent Application Publication
(10) Pub. No.: US 2013/0135170 A1
(43) Pub. Date: May 30, 2013

(54) PRINTED ANTENNA

(71) Applicants: CHING-HSIANG KO, New Taipei (TW); Kai Shih, New Taipei (TW); Lan-yung Hsiao, New Taipei (TW); Jia-hung Su, New Taipei (TW)

(72) Inventors: CHING-HSIANG KO, New Taipei (TW); Kai Shih, New Taipei (TW); Lan-yung Hsiao, New Taipei (TW); Jia-hung Su, New Taipei (TW)

(73) Assignee: Cheng Uei Precision Industry Co., LTD., New Taipei City (TW)

(21) Appl. No.: 13/304,394

(22) Filed: Nov. 24, 2011

(51) Int. Cl. H01Q 1/38; H01Q 1/48

(52) U.S. Cl. 343/848; 343/700 MS

(57) ABSTRACT

A printed antenna is disclosed. The printed antenna includes a substrate and an electrically conductive layer formed on a top surface of the substrate. The electrically conductive layer comprises a first radiation part, a second radiation part, a first feed part, a second feed part, and a grounding part. The first radiation part is connected with the first feed part. The second radiation part is connected with the second feed part. The grounding part is connected with the first radiation part and the second radiation part. In the printed antenna of the present invention, the first feed part and the second feed part feed into two electromagnetic signals so as to implement a dual antenna function. Furthermore, the arrangement is reasonable, and the manufacturing cost is low.

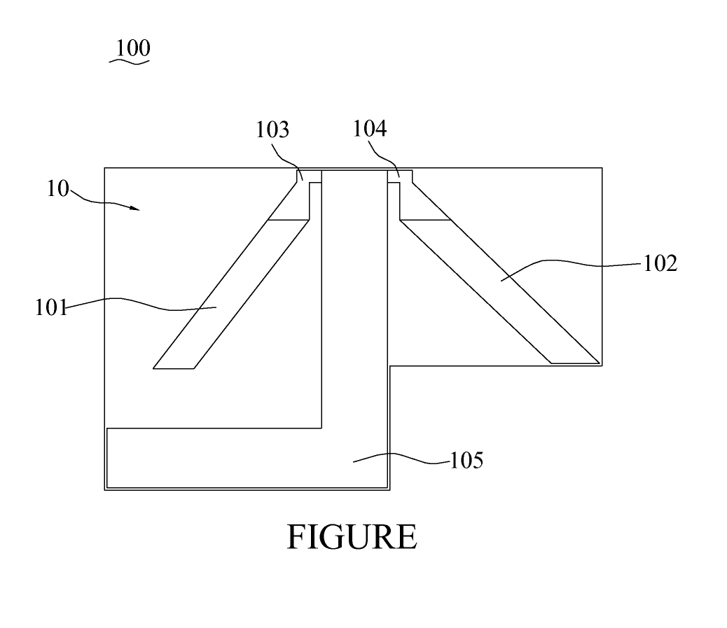

### BACKGROUND OF THE INVENTION

1. Field of the Invention

The present invention generally relates to an antenna technical field in wireless communication products, and more particularly to a printed antenna.

2. Description of Prior Art

With high speed development of mobile communication in recent years, demands for portable and mobile communication terminals, such as mobile phones or notebooks, are higher. Users wish that sizes of these portable and mobile communication terminals are integrated to be small.

When the sizes of these portable and mobile communication terminals tend to be small, the manufacturing cost is required to be control. Accordingly, each element of these portable and mobile communication terminals would be identified, and the cost would be decreased.

An antenna is necessary element when a mobile communication terminal proceeds to communicate with other mobile communication terminal or terminals. To decrease the size of the mobile communication terminal, the antenna is usually built in the mobile communication terminal. However, a frequency band number and cost of a built-in antenna are limited, and thus such a built-in antenna is not popular. Accordingly, designing a low cost and reasonable arrangement antenna becomes a development trend in the antenna industry.

### SUMMARY OF THE INVENTION

To solve the above-mentioned deficiencies in the prior arts, an objective of the present invention is to provide a printed antenna having a reasonable arrangement and a low manufacturing cost.

To implement the above-mentioned objective, the printed antenna in accordance with the present invention comprises a substrate and an electrically conductive layer formed on a top surface of the substrate. The electrically conductive layer comprises a first radiation part, a second radiation part, a first feed part, a second feed part, and a grounding part. The first radiation part is connected with the first feed part. The second radiation part is connected with the second feed part. The grounding part is connected with the first radiation part and the second radiation part. The first radiation part and the first feed part are positioned at one side of the grounding part, and the second radiation part and the second feed part are positioned at another one side of the grounding part.

More particularly, each of the first radiation part and the second radiation part is strip-shaped.

More particularly, the grounding part is inverted L-shaped.

More particularly, the first feed part and the second feed part are connected with one end of the grounding part and symmetrically positioned at two sides of the one end of the grounding part, and the first radiation part and the second radiation part are symmetrically disposed at the two sides of the grounding part.

More particularly, one end of the first radiation part is connected with the first feed part, another one end of the first radiation part is obliquely and outwardly extended away from the grounding part, one end of the second radiation part is connected with the second feed part, and another one end of the second radiation part is obliquely and outwardly extended away from the grounding part.

More particularly, the first radiation part and the second radiation part receive and transmit electromagnetic signals in a frequency band of 2.4 GHz.

More particularly, each of the first radiation part and the second radiation part is a plated copper layer, while each of the first feed part the second feed part, and the grounding part is a plated gold layer.

More particularly, the top surface and a bottom surface of the substrate are coated by a layer of black paint, and the layer of black paint covers the electrically conductive layer.

More particularly, the printed antenna is a planner inverted F antenna.

Compared with the prior arts, the printed antenna comprises the first radiation part and the second radiation part, and the first feed part and the second feed part feed into two electromagnetic signals so as to implement the dual antenna function. Furthermore, the first radiation part and the first feed part are positioned at one side of the grounding part, while the second radiation part and the second feed part are positioned at another one side of the grounding part. As a result, the arrangement is reasonable, and the manufacturing cost is low.

### BRIEF DESCRIPTION OF THE DRAWINGS

The FIGURE is a structural diagram of a printed antenna in accordance with an embodiment of the present invention.

### DETAILED DESCRIPTION OF THE INVENTION

Please refer to the FIGURE, a printed antenna in accordance with the present invention comprises a substrate 10 and an electrically conductive layer (an oblique-line area as shown in FIGURE) formed on a top surface of the substrate 10. The electrically conductive layer comprises a first radiation part 101, a second radiation part 102, a first feed part 103, a second feed part 104, and a grounding part 105.

The substrate 10 is a printed circuit board (PCB). Preferredly, the top surface and a bottom surface of the substrate 10 are coated by a layer of black paint. The layer of black paint covers the electrically conductive layer so as to protect the electrically conductive layer. The printed antenna 100 is a planner inverted F antenna (PIFA) which comprises at least one metal plating layer on the printed circuit board. In one embodiment, each of the first radiation part 101 and the second radiation part 102 is a plated copper layer, while each of the first feed part 103, the second feed part 104, and the grounding part 105 is a plated gold layer.

In one embodiment, the grounding part 105 is inverted L-shaped.

In one embodiment, the first radiation part 101 is connected with the first feed part 103. The second radiation part 102 is connected with the second feed part 104. The grounding part 105 is connected with the first radiation part 103 and the second radiation part 104. The first radiation part 101 and the first feed part 103 are positioned at one side of the grounding part 105, while the second radiation part 102 and the second feed part 104 are positioned at another one side of the grounding part 105.

In one embodiment, the first feed part 103 and the second feed part 104 are connected with one end of the grounding part 105 and symmetrically positioned at the two sides of the one end of the grounding part 105. The first radiation part 101 and the second radiation part 102 are symmetrically disposed at the two sides of the grounding part 105. One end of the first radiation part 101 is connected with the first feed part 103, and another one end of the first radiation part 101 is obliquely and outwardly extended away from the grounding part 105. One end of the second radiation part 102 is connected with the second feed part 104, and another one end of the second radiation part 102 is obliquely and outwardly extended away from the grounding part 105.

In one embodiment, each of the first radiation part 101 and the second radiation part 102 is strip-shaped, and the first radiation part 101 and the second radiation part 102 receive and transmit electromagnetic signals in a frequency band of 2.4 GHz.

An operation principle of the present invention is described as the following: two electromagnetic signals in the frequency band of 2.4 GHz respectively pass the first feed part 103 and the second feed part 104 and feed into the first radiation part 101 and the second radiation part 102, and then the first radiation part 101 and the second radiation part 102 respectively radiate the two electromagnetic signals. As a result, the printed antenna in accordance with the present invention is a dual antenna.

As mentioned above, the multi-band printed antenna 100 comprises the first radiation part 101 and the second radiation part 102, and the first feed part 103 and the second feed part 104 feed into two electromagnetic signals so as to implement the dual antenna function. Furthermore, the first radiation part 101 and the first feed part 103 are positioned at one side of the grounding part 105, while the second radiation part 102 and the second feed part 104 are positioned at another one side of the grounding part 105. As a result, the arrangement is reasonable, and the manufacturing cost is low.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A printed antenna, comprising a substrate and an electrically conductive layer formed on a top surface of the substrate, wherein the electrically conductive layer comprises a first radiation part, a second radiation part, a first feed part, a second feed part, and a grounding part, the first radiation part is connected with the first feed part, the second radiation part is connected with the second feed part, the grounding part is connected with the first radiation part and the second radiation part, the first radiation part and the first feed part are positioned at one side of the grounding part, and the second radiation part and the second feed part are positioned at another one side of the grounding part.

2. The printed antenna as claimed in claim 1, wherein each of the first radiation part and the second radiation part is strip-shaped.

3. The printed antenna as claimed in claim 1, wherein the grounding part is inverted L-shaped.

4. The printed antenna as claimed in claim 1, wherein the first feed part and the second feed part are connected with one end of the grounding part and symmetrically positioned at two sides of the one end of the grounding part, and the first radiation part and the second radiation part are symmetrically disposed at the two sides of the grounding part.

5. The printed antenna as claimed in claim 1, wherein one end of the first radiation part is connected with the first feed part, another one end of the first radiation part is obliquely and outwardly extended away from the grounding part, one end of the second radiation part is connected with the second feed part, and another one end of the second radiation part is obliquely and outwardly extended away from the grounding part.

6. The printed antenna as claimed in claim 1, wherein the first radiation part and the second radiation part receive and transmit electromagnetic signals in a frequency band of 2.4 GHz.

7. The printed antenna as claimed in claim 2, wherein the first radiation part and the second radiation part receive and transmit electromagnetic signals in a frequency band of 2.4 GHz.

8. The printed antenna as claimed in claim 1, wherein each of the first radiation part and the second radiation part is a plated copper layer, while each of the first feed part the second feed part , and the grounding part is a plated gold layer.

9. The printed antenna as claimed in claim 1, wherein the top surface and a bottom surface of the substrate are coated by a layer of black paint, and the layer of black paint covers the electrically conductive layer.

10. The printed antenna as claimed in claim 1, wherein the printed antenna is a planner inverted F antenna.
